(19) United States
(12) Patent Application Publication
(10) Pub. No.: US 2026/0024745 A1
(43) Pub. Date: Jan. 22, 2026

(54) METHOD AND SYSTEM FOR MAKING A LITHIUM ANODE FOR A BATTERY

(71) Applicant: GM GLOBAL TECHNOLOGY OPERATIONS LLC, Detroit, MI (US)

(72) Inventors: Shaomao Xu, Sterling Heights, MI (US); Daniel Ryan, Fenton, MI (US); Hassan Ghassemi-Armaki, Northville, MI (US)

(73) Assignee: GM GLOBAL TECHNOLOGY OPERATIONS LLC, Detroit, MI (US)

(21) Appl. No.: 18/774,908

(22) Filed: Jul. 16, 2024

(51) Int. Cl. H01M 4/04; H01M 4/02; H01M 4/38; H01M 4/66; H01M 10/052

(52) U.S. Cl. CPC H01M 4/0483; H01M 4/0435; H01M 4/382; H01M 4/661; H01M 10/052; H01M 2004/027; H01M 2220/20

(57) ABSTRACT

A method includes providing a current collector comprising metal and forming a lithium layer on at least one side of the current collector. This includes dipping the current collector into a bath of molten lithium, and controlling the thickness of the lithium layer at least partly by at least one of: setting a line speed through the bath or a resident time that the current collector is to be within the bath. Then, the method provides the current collector with the lithium layer to form a lithium metal anode for a battery cell.

### INTRODUCTION

The present disclosure relates to lithium metal batteries, and more particularly, manufacturing processes to make high performance lithium metal anodes for a vehicular battery.

Lithium metal batteries have been considered a promising next-generation battery for electric vehicles and other devices. As lithium metal provides relatively high specific capacity, improvements continue to be made in the development of lithium batteries, particularly in the solid-phase lithium metal battery production.

### SUMMARY

In an example implementation, a method includes providing a current collector including metal and forming a lithium layer on at least one side of the current collector. This includes dipping the current collector into a bath of molten lithium. The method also includes controlling the thickness of the lithium layer at least partly by at least one of: setting a line speed through the bath or a resident time that the current collector is to be within the bath. Then, the method provides the current collector with the lithium layer to form a lithium metal anode for a battery cell.

Also in an example implementation, the dipping includes moving the current collector through the bath of molten lithium to provide a lithium layer on both a front and back of the current collector.

Also in an example implementation, the method includes moving the current collector under at least one fixture that forcing, by the at least one fixture, the current collector into the molten lithium.

Also in an example implementation, the method includes heating a lower end of the fixture that is directly or indirectly in contact with the current collector in the molten lithium.

Also in an example implementation, the method includes vertically moving the fixture to adjust tension in the current collector.

Also in an example implementation, the fixture has a lower end with a roller disposed within the molten lithium, and the method includes passing the current collector under the roller.

Also in an example implementation, the method includes replacing or adjusting the diameter of the roller to adjust tension in the current collector.

Also in an example implementation, a coating tub has an interior first surface in direct contact with the molten lithium. The method includes extending at least one second surface of the at least one fixture into the coating tub and placing the at least one second surface in direct contact with the molten lithium. Also, the method includes forming the first and second surfaces of a material inert to lithium.

Also in an example implementation, the method includes forming the first and second surfaces of stainless steel or SS-316.

In an example implementation, a system of making lithium anodes for a vehicle battery includes a conveyor mechanism having rollers spaced along a path to move a current collector through the system. A coating tub is provided to receive the current collector and holding a bath of molten lithium to dip the current collector into the molten lithium. The rollers are arranged to descend the current collector into the bath and to raise the current collector out of the bath.

Also in an example implementation, the system includes at least one heater below the coating tub and disposed to heat the molten lithium in the bath.

Also in an example implementation, the coating tub has at least one sidewall, and wherein the system includes at least one heater on the at least one sidewall to heat the bath of molten lithium.

Also in an example implementation, the system includes a plurality of the heaters disposed vertically on the at least one sidewall to each radiate at different temperatures to establish a gradient of temperatures vertically along a depth of the molten lithium within the coating tub.

Also in an example implementation, the at least one sidewall has at least one indent receiving at least part of the at least one heater.

Also in an example implementation, the conveyor mechanism includes a descending portion and a rising portion respectively extending into and out of the bath of molten lithium. The system includes at least one heater disposed to be directed toward the current collector on the descending portion.

Also in an example implementation, the system includes a supply container to hold heated molten lithium, and an injection channel fluidly coupling the supply container to an interior of the coating tub to feed lithium from the supply container into the coating tub.

Also in an example implementation, the molten lithium in the supply container is maintained at a temperature of about one-half the melting point of lithium or about 100° C. or 100.0° C. or 90.25° C.

Also in an example implementation, the system includes multiple fixtures extending within the coating tub and along a path of the current collector. The multiple fixtures are spaced from each other at a distance within the coating tub, and the multiple fixtures hold the current collector in the molten lithium over the distance.

Also in an example implementation, one of the rollers is an automatically rotatable take-up roller that winds the current collector with a lithium layer around the take-up roller. The take-up roller has at least one sensor to sense tension in the current collector.

In an example implementation, a method includes moving a metal current collector having front and back metal oxygen layers down into a coating tub holding a bath of molten lithium. The method also includes moving the current collector under at least one fixture extending into the coating tub and the molten lithium, and coating both the front and back metal oxide layers on the current collector with a lithium layer of molten lithium. The method then moves the current collector having the lithium layers upward and out of the coating tub, and rolls the current collector with the lithium layers onto a take-up roller.

### BRIEF DESCRIPTION OF THE DRAWINGS

The present disclosure will hereinafter be described in conjunction with the following figures, where like numerals denote like elements and the figures are not to scale, and where:

FIG. 1A is a schematic diagram of an example system for making a lithium anode for a battery cell according to at least one of the implementations herein;

FIG. 1B is a schematic diagram of a cross-sectional view of an alternative example current collector processing configuration used with the system of FIG. 1A according to at least one of the implementations herein;

FIG. 2A is a schematic diagram of an example lithium coating stage of the system of FIG. 1A and according to at least one of the implementations herein;

FIG. 2B is a schematic diagram of a simplified cross-sectional side view of an example portion of a coating tub used in the coating stage of FIG. 2A and according to at least one of the implementations herein;

FIG. 2C is a schematic diagram of a simplified cross-sectional side view of another example portion of a coating tub used in the coating stage of FIG. 2A and according to at least one of the implementations herein;

FIG. 3 is a schematic diagram of an alternative example coating stage of the system of FIG. 1 and according to at least one of the implementations herein;

FIG. 4 is a flowchart of a method of making a lithium anode for a battery cell implemented by the systems in FIGS. 1-3 according to at least one of the implementations herein;

FIG. 5 is a schematic diagram of a cross-sectional view of an alternative example lithium anode arrangement according to at least one of the implementations herein; and

FIG. 6 is a schematic diagram of a cross-sectional view of another alternative example lithium anode arrangement according to at least one of the implementations herein.

### DETAILED DESCRIPTION

The following detailed description merely describes example implementations and are not intended to limit the disclosure or the application and uses thereof. Furthermore, no intention exists to be bound by any theory presented in the preceding background or the following detailed description.

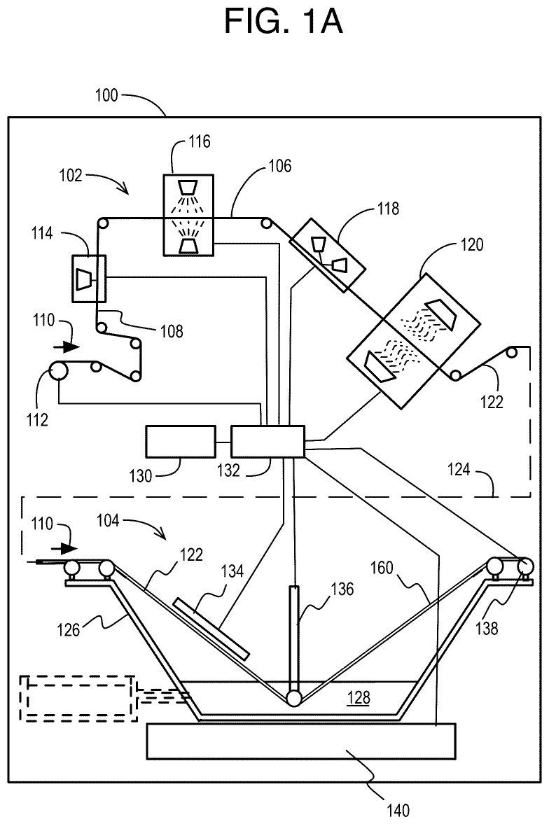

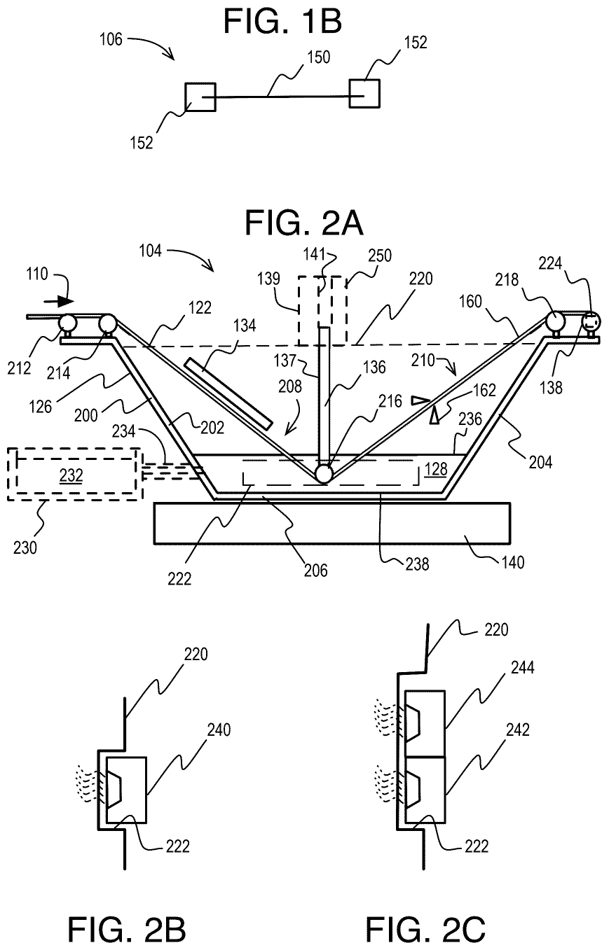

Referring to FIG. 1, the present disclosure includes example systems, methods, and devices for manufacturing thin lithium metal anodes, and by one form, for vehicular batteries. Here, an example system 100 has an example pre-treatment stage 102 and an example lithium coating stage 104 that forms a lithium metal anode by treating and coating a current collector 106 that is described herein as being in the form of a foil, web, or sheet. By one form, the current collector 106 is dipped into a bath of molten lithium in the coating stage 104 to submerge the current collector 106 in the molten lithium bath thereby forming a high quality continuous lithium layer without significant limitations in line speed related to forming the lithium layer and that can be formed in a wide range of production target dimensions and compositions. Thus, the present methods using a molten lithium bath can enable high speed manufacturing of lithium anodes, and can produce extremely wide lithium anodes with a uniform lithium coating thickness.

By one optional approach, a metal oxide layer may be deposited on the current collector 106 during the pre-treatment stage 102 to provide an enhanced wettability such that molten lithium may be more effectively adhered to the current collector 106. As a result, a relatively thin lithium metal anode may be manufactured. The relatively thin lithium metal anode then may be formed by the dip coating to match a cathode capacity to enable high performance, stable cyclability, and enhanced battery efficiency.

By other options, however, many different types of pre-treatment may be used in pre-treatment stage 102 or the pre-treatment stage 102 may be omitted altogether. Thus, in some cases, the pre-treatment layer may be a treatment of the surface or surfaces of the current collector 106, such as roughening, without the addition of any other layers. Also, in the latter case, a current collector 106, made of copper for example, may be provided directly to the coating stage 104 without the addition of any layers or pre-treatment. Many variations are contemplated.

In detail for one example pre-treatment stage 102 here, the current collector 106 may be an elongated foil wound around a feed roller 112. By one form, the current collector 106 may be about 5-20 microns thick by one example. The current collector 106 then is moved or unwound in a forward direction 110 along a path 108 and directed by a number of guide rollers. The feed roller 112 may be controlled automatically, such as by electric motor or solenoid, or manually such as by a hand crank. As will be described in greater detail below for this example, the current collector 106 may be unwound as the current collector 106 undergoes surface treatment of metal oxide and coating of molten lithium thereon. In this implementation, the metal of the current collector 106 is comprised of copper, nickel, or combinations or alloys thereof. Other materials could be used in addition or instead.

In this example, the pre-treatment stage 102 may have a first quality measurement unit 114 for measuring the thickness and uniformity of the thickness (or flatness) of the current collector 106 to better ensure the metal oxide layer(s) is meeting quality thresholds for example. The measurement unit 114 may perform the measurements by using laser profile measurement, for example. Then, a spray unit 116 is positioned to spray a precursor solution (here on both back and front sides of the current collector 106), and of a metal oxide compound. In this example, the spraying creates a precursor layer on both a front and a back of the current collector 106. By one example form, the precursor solution comprises one of zinc nitrate, aluminum nitrate, and titanium nitrate. Moreover, the metal oxide compound may be one of zinc oxide, aluminum oxide, and titanium oxide. It is to be understood that the precursor of zinc oxide is zinc nitrate, the precursor of aluminum oxide is aluminum nitrate, and the precursor of titanium oxide is titanium nitrate. It is also to be understood that other metal oxides along with corresponding precursors may be used.

By another example, a precursor solution to be sprayed may comprise the precursor and a solvent such as ethanol. The spray unit 116 may apply the precursor solution to the front or back or both sides of the current collector 106 by any suitable mechanism.

Referring to FIG. 1B for yet another example, the current collector 106 may have a web or foil 150 with edges that are covered by masks 152 so that no precursor is applied on the edges. The masks 152 may remain on the edges of the foil 150 throughout the remaining pre-treatment stage 102 and the coating stage 104. In this case, the masks 152 are removed after the coating stage 104 so that no or little lithium is applied to the edges leaving the copper or other material of a resulting current collector 160 (FIG. 1A) exposed so that the exposed edges may be used as a tap for other electrical connections.

Continuing with pre-treatment stage 102, the system 100 next may use a second quality measurement unit 118 that may be an X-ray unit that has an X-ray florescent (XRF) detector and XRF source as one possible example to measure the metal oxide layer composition and thickness to better ensure the metal oxide layer(s) is meeting quality thresholds for example.

The system 100 further comprises a pre-heating unit 120 with a heater configured to heat the precursor layers on the front and back of the current collector 106 at a predetermined temperature, and by one example, for between about 3 to 30 minutes to decompose the precursor solution, and by one form, by using lasers for example. Upon reaching the predetermined temperature, the precursor decomposes to the corresponding metal oxide. The decomposition of the precursor solution defines metal oxide layers with one disposed on each side of the current collector 106 in this example, although such treatment could be for one side of the current collector 106 instead. Example predetermined temperatures radiated by the heater 120 may be about 200, 250, or 300 degrees Celsius, and where the metal oxide layer may have a thickness of about 50 to 500 nanometers, and by one form, 100 nanometers.

In this example, the result of the pre-treatment stage 102 is a current collector 122 with a flat metal core (such as copper) and metal oxide layers on the front and back, or surrounding, the flat metal core or middle layer. A path 124 shows the current collector 122 is directed to the coating stage 104. As mentioned above, however, alternatively the current collector 122 may be provided without any pre-treatment layers when desired.

In the present example, the coating stage 104 includes dipping the current collector 122, with the metal oxides layers when present, into a molten lithium bath 128 (128 is called bath, molten lithium and molten lithium bath) to coat the lithium onto the metal oxide layers, when present, and directly or indirectly onto the current collector 122. A coating unit, that here is a coating tub 126, holds the molten lithium. At least one fixture 136 holds the current collector 122 in the molten lithium, and at least one or more heaters 134 and 140 are provided to maintain the current collector 122 and molten lithium 128 at temperatures conducive for coating the lithium onto the current collector 122.

Referring to FIG. 2A for more detail, the example coating tub 126 includes two slanted sidewalls including an upstream sidewall 202 and a downstream sidewall 204, a bottom or base plate 206 extending longitudinally between the sidewalls 202 and 204. The base plate 206 extends laterally between left and right lateral sidewalls 220 (shown by the dashed line), where lateral is relative to the forward or longitudinal direction of the path 110 of the current collector 122 and 160. This forms a tub interior that can hold the molten lithium bath 128 with a depth that runs from a bottom 238 of the bath formed at the base plate 206 of the coating tub 126 and up to a top 236 of the bath 128 at a desired height from the bottom 238 of the bath 128. The upstream and downstream sidewalls 202 and 204 are slanted to reduce the volume of the bath 128, thereby reducing the cost of the lithium material.

The entire coating tub 126, or at least the interior of the coating tub 126, may be located within an environment or atmosphere inert to lithium, such as argon. Thus, it is to be understood that the inert atmosphere may be a closed environment or atmosphere containing gas that is not chemically reactive, particularly to lithium and when present, to other layers being used such as metal oxide. For example, the inert atmosphere may be at about 1 atm argon at room temperature. Moreover, for one example, the inert atmosphere is preferably a non-nitrogen, a non-oxygen, a non-air, and a non-carbon dioxide atmosphere.

For the present example, the coating unit 126 also may have rollers 212, 214, 216, 218, and 138 to form the path 110 (110 used for forward direction) for the current collector 122 into and out of the bath 128, thereby establishing a roller-to-roller (R2R) or similar process. It should be noted that the first or entry roller 212 may be a feed roller that provides a wound current collector 122 to be coated when no pre-treatment stage 102 or other stage to provide the current collector is being used. Entry rollers 212 and 214 guide the current collector 122 toward a descending portion 208 of the path 110. The current collector 122 is then guided under a fixture roller 216 at a lower end of the fixture 136 at a bottom of the descending portion 208 and in the molten lithium 128 to hold the current collector 122 down and in the molten lithium 128. Thereafter, the current collector 122 is guided upward and out of the bath 128 along an ascending portion 210 of the path 110 and to exit roller 218 and then finally at a take-up (or end) roller 138 where the lithium coated current collector 160 is wound around the roller 138. It will be understood that, herein, discussion of the coating of the molten lithium on the current collector 122 includes the molten lithium being indirectly on the current collector 122 with any intermediate layers disposed between the current collector 122 and the molten lithium. Thus, coating the molten lithium on the current collector 122 includes coating the lithium on metal oxide layers or other intermediate layers on the current collector 122 (or in other words, indirectly coating the current collector 122 with the molten lithium).

By one form, once the current collector 160 is removed from the bath 128, the inert environment at room temperature (or at least below the melting point of lithium or about 180° C.) is sufficient to cool the molten lithium layer on the current collector 160 to form a sufficiently solid lithium layer so that rolling up the coated current collector 160 on the take-up roller 138 does not damage the lithium layer on the current collector 160.

The fixture 136 is shown here with a mounting structure 250 that can be many different structures, and that may be controlled manually or automatically. By one example form, this may include two vertical rails 137 (where one is shown) and can be moved up into an opening 139 of a block 141. The block 141 or the rail 137 or both may have a vertically extending array of holes (not shown) so that the rail 137 and roller 216 can be set at a particular desired height relative to the top surface 236 of the bath 128. Such rails 137 may be at the sidewalls 220, within a sleeve or bracket attached to the sidewalls 220, or may be external to the sidewalls 220, whether free standing or having a base and/or supports. Also, the rails may even be inside of the tub 126, whether inside of the bath 128 and offset from the lateral sides of the current collector 122/160, or between the bath 128 and the sidewalls 220 when the bath does not extend the entire width between the sidewalls 220. Otherwise, the rails 137 may have a base in the tub and that is surrounded by the bath 128 but extending upwardly to avoid the molten lithium in the bath 128. Pins, bolts or other fasteners (not shown) may be used to adjustably attach the roller 216 and rails 137 to the block 141 or other mounting structure. Many other alternative variations exist that can be used instead to at least move the roller 216 vertically to a desired position to force the current collector 122 into the molten lithium bath 128. It will be understood that such structures also may include tracks, beams, or other components so that a horizontal position of the one or more rollers 216 can be adjusted longitudinally within the tub 126 as well.

By one implementation, the height of the lower end of the fixture 136 or roller 216 here may be set to provide sufficient tension in the current collector 122/160 along the path 110, and in turn to establish good contact between the current collector 122/160 and the molten lithium 128. Such tension is determined by experimentation and must be sufficient to hold the current collector flat (without too much slack) for efficient coating of the lithium since uncontrolled bending of the current collector can cause lithium to separate or not coat onto the current collector. The tension cannot be too strong, which can cause the current collector to tear. As another parameter, the diameter of the roller 216 can be set to establish or contribute to achieving a desired tension in the current collector.

By another implementation, the take-up roller 138 may be used to assist with tension control as well. Specifically, the take-up roller 138 may be an automated take-up roller with a force sensor 224 to adjust the line speed depending on the sensed tension of the current collector 122/160. The automatic rotation of roller 138, or any of the other rollers that are being used, may be accomplished by using a rotor rotated by rotary solenoid, rack and pinion mechanisms, lever and crank mechanisms, cams, and/or many other devices. The force sensor 224 may be a roller tension sensor mounted on, or in, the roller 138. The tension of the current collector 122/160 may need to meet a low and high threshold for the reasons mentioned above and is adjusted accordingly by rotation of the roller 138 when the thresholds are not being met.

Both the rotation of the roller 138 and reading of the sensor 224 may be controlled by a controller 132 (FIG. 1) of the system 100 and that is powered by a power source 130. The controller 132 may control a number of the units or components of both the pre-treatment stage 102, when being used, and the coating stage 104. This includes the feed roller 112, first quality measurement unit 114, spray unit 116, second quality measurement unit 118, pre-heating unit 120, take-up roller 138, force sensor 224, and/or any of the coating tub heaters mentioned herein, and any one or combination of these. This also includes automating or controlling the rotation of any of the rollers mentioned herein. The power source 130 may be any suitable power source, whether battery power, AC, DC, and so forth.

In addition to the inert environment around the lithium bath 128, surfaces of the coating tub 126 and the fixture 136 in direct contact with the molten lithium is formed of a material inert to the molten lithium as well. By one example, this includes any surface of any component of the system 100 in direct contact with the molten lithium. By one form, such surfaces are formed of stainless steel or SS-316. By other forms, this may include materials, metals, alloys, or compositions that can include iron, chromium, nickel, molybdenum, manganese, silicon, carbon, a nickel-based superalloy, a ceramic, a refractory metal, tungsten, tantalum, and aluminide, for example, but for any of these materials that are not sufficiently inert to lithium, then only trace amounts of those materials can be present.

The coating unit 126 also may have one or more heaters to maintain the molten lithium at a temperature conducive to coating the lithium directly or indirectly onto the current collector 122. If the temperature of the molten lithium is too low, the viscosity of the molten lithium 128 increases, which results in the lithium becoming sticky or starting to solidify so that the lithium cannot flow and spread easily and evenly over the current collector 122. In this case, a lithium layer will be uneven on the current collector or will not form at all.

By one form, the temperature of the molten lithium is maintained at about 220-370° C., and by another form at about 240° C. By yet another form, the molten lithium is between about 200-350° C., or the temperature is between about 220-280° C. By one other form, the temperature is about 250° C.

To maintain these molten lithium temperatures in one implementation, the coating unit 126 has the bottom heater 140 that is below, and by one form in contact with, the base plate 206 of the coating tub 126. By one form, the bottom heater 140 extends along the entire base plate 206, but otherwise, may extend on selected parts of the bottom 206 of the coating tub 126, such as near a center of the base plate 206, just at the boundary of the base plate 206, in some other pattern such as an ‘X’, a coil, or any other desired pattern. These arrangements may be used for any of the heaters described herein.

Also by one implementation, a current collector heater 134 may be disposed on the descending portion 208 of the path 110 so that the current collector is heated while it moves downward toward the molten lithium bath 128 and enters the molten lithium bath 128 to avoid cooling and/or solidifying of the molten lithium in the bath 128. By one form, the current collector heater 134 radiates heat at least at half the melting point of lithium, such as 90-100° C., but can be higher.

Also by one implementation, the fixture roller(s) 216 (or any roller in the bath 128) can be heated as well to avoid lowering the molten lithium temperature, and such as by a cartridge heater within the roller 216 itself for example. By one form, the roller heater radiates heat at least at half the melting point of lithium, such as 90-100° C. but can be higher.

Referring to FIG. 2B, and by another implementation, heaters may be provided at the upstream, downstream, and/or lateral sidewalls 202, 204, 220 as desired. Thus, by one example sidewall 220 shows an indent 222 shaped and sized to receive and a sidewall heater 240. By one form, the sidewall heater 240 is held at the height and location of the bath 128. This may be repeated for any of the sidewalls.

Referring to FIG. 2C for another implementation, multiple heaters establish a temperature gradient along a depth of the molten lithium bath 128. For example, two heaters including a lower heater 242 below an upper heater 244 are in an indent 222 of a sidewall 220. The heaters 242 and 244 are stacked or vertically aligned to generate a temperature gradient from the top 236 to the bottom 238 of the molten lithium bath 128. For example, the upper heater 244 may emit less heat (or lower temperature) than the lower heater 242 when the fixture 136 is to hold the current collector 122 at a depth even with the lower heater for precise coating efficiency temperature for example. Thus, by one example form, both the lower and upper heaters 242 and 244 are still set to emit heat above the melting point of lithium, except that the lower heater 242 may emit heat at a higher temperature than the upper heater 244. By one form, the heaters may be stacked one on the other, or may have shelves, brackets, separate indents 222, or other structure to hold the heaters in place in proximity to the sidewall 202, 204, or 220. Many variations for mounting the heaters to the coating tub 126 exist.

Any of these heaters 134, 140, 240, 242, and 244 may be electric, electric resistance heaters, tubular heaters, cartridge heaters, induction or induction coil heaters, infrared heaters, quartz heaters, immersion heaters, screw plug or flanged immersion heaters, gas-fired heaters, and/or any other type of heater that can sufficiently provide heat to the molten lithium 128.

As another approach to efficiently maintain the temperature of the molten lithium in the bath 128, an optional supply or preheat container (or tub) 230 may be provided to hold a supply bath 232 of feed lithium and that is fluidly coupled to the coating tub 126 by a channel 234. By this example, the supply bath 232 is heated to about one-half the melting point of lithium, or about 90 to 100° C. or about 90° C. or 90.25° C., or 100° C. The supply container 230 may have its own heat source (not shown) or share a heat source with the coating tub 126. The injection of the lithium from the supply bath 232 and through the channel 234 to the coating bath 128 may be by gravity, pump, gas compression when the container 230 is sealed, or mechanically by cylinder and/or piston. Many other variations or alternatives to these may be used to inject the supply lithium into the coating tub 126.

The coating tub 126 also may have a thickness control device 162 to control the thickness of the molten lithium coating on the current collector 160. By one example, the thickness control device 162 is or has two or more reducers, such as doctor or metering blades positioned a specific spacing from both the front and back of the current collector 160 to scrape away excess lithium on the current collector 160. This creates a lithium layer with a uniform thickness. In one implementation, the desired lithium layer thickness on each side of the current collector 160 is about 10-200 microns, about 10-50 microns, or about 10-20 microns.

As another implementation, in addition to, or instead of, the thickness control device 162, the thickness of the lithium layer on the current collector 160 is controlled by setting a line speed and/or controlling the resident time the current collector is in the molten lithium. Generally, the longer the current collector 122 is in contact with the molten lithium bath 128, the thicker a resulting lithium layer on the current collector 122. This can be performed in a number of different ways. Specifically, the speed of the feed and/or take-up rollers 112 (or 212) and/or 138 may be adjusted by using controller 132 for example so that the duration that the current collector 122 is touching or submerged (or “resident”) in the molten lithium bath 128 is precisely controlled. This may include stopping the forward motion of the current collector 122 one or more times such as at uniform intervals or intervals determined by other factors to increase the resident time of the current collector 122 in the bath 128.

By another example approach, the current collector may be dipped multiple times into the molten lithium bath 128 either in series by alternating low and high fixture rollers along path 110 for example, or by having a moving mechanism, such as vertically moving rollers, that move up and down to alternately lower the current collector into the bath 128 and raise the current collector out of the bath 128 a desired number of cycles. The current collector 122 may or may not be moved forward during these multiple dips.

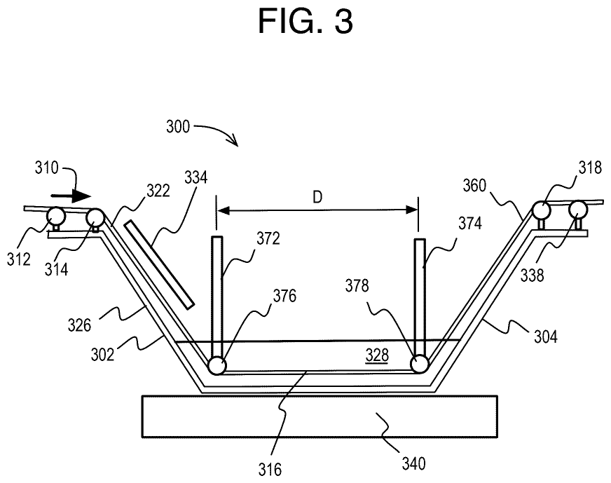

Referring to FIG. 3, another example for increasing the resident time for the current collector 322 to be in contact with, or submerged within, the molten lithium bath uses multiple fixtures. Specifically, an alternative lithium coating system 300 has a coating unit or coating tub 326 that guides a current collector 322 into a molten lithium bath 328, and has some of the same or similar components as system 100 (FIGS. 1-2). Those same or similar components are numbered similarly and need not be described again. In this example, the coating tub 326 has a fixture 372 spaced from a fixture 374 a predetermined distance D. Each fixture 372, 374 has a respective roller 376, 378 (or other structure) to hold the current collector 322 downward in the molten lithium bath 328 while permitting the current collector 322 to move forward in direction 310. The fixtures 372, 374 may be set apart from each other at a maximum distance for D where the current collector 322 will not touch upstream and downstream sides 302 and 304 of the tub 326. At a maximum distance for D, the current collector 322 will have a submerged portion 316 between the two fixtures 372 and 384 with a maximum amount of contact surface area for coating in the bath 328. When a smaller amount of contact surface area is desired, the fixtures 372 and 374 may be set closer to each other. Also, there may be more than two fixtures when desired, especially to hold the current collector 322 in the bath 328 with less tension in the current collector 322 for example. Otherwise, the operation of the coating system 300 may be the same or similar to that already described above with system 100.

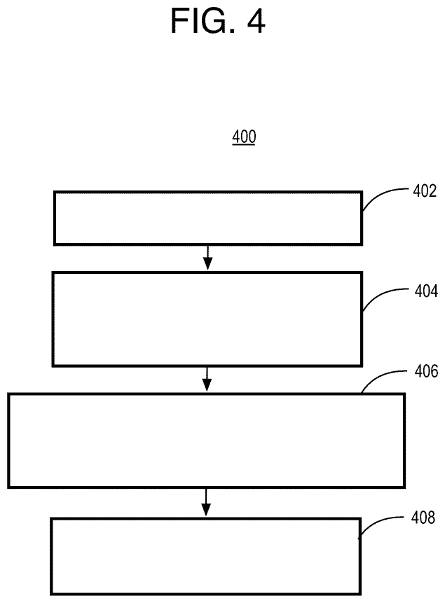

Referring to FIG. 4, a process 400 of manufacturing a lithium battery anode is described in accordance with at least one of the implementations herein, and includes operations 402 to 408 numbered evenly. The description of process 400 may refer to any of the systems and components thereof described with FIGS. 1-3 and 5-6, where relevant.

Process 400 may include “provide a current collector comprising metal” 402, and as mentioned above, may be either copper or nickel in one example, and in the form of a rolled foil (or sheet or web).

As a preliminary matter, the current collector may be pre-treated to have a treated surface (such as roughened to increase friction) or to have an intermediate layer, such as metal oxide layers, deposited either on one or both sides of the current collector. The metal oxide layers are as described above and may be provided to increase wettability of the current collector.

Process 400 may include “form a lithium layer on at least one side of the current collector comprising dipping the current collector into a bath of molten lithium” 404. This involves guiding the current collector, such as by rollers, into and out of the bath of molten lithium. The bath is heated to maintain the lithium in a molten state rather than solid and to decrease viscosity of the molten lithium so that the molten lithium easily flows and spreads onto the current collector. The molten lithium is also maintained in an inert atmosphere, such as argon or others, while the materials of the tub, fixture, and/or anything else in contact with the lithium is formed of an inert material such as stainless steel or SS-316.

The process 400 also may include “control a thickness of the lithium layer at least partly by at least one of: setting a line speed through the bath or a resident time that the current collector is to be within the bath” 406, and also as described above. This may include controlling the line speed by automatically controlling rollers for example, by slowing or stopping the rollers to increase the resident time of the current collector in the bath such as to increase the thickness of a lithium layer on the current collector. Otherwise, the roller or rotation speed may be increased to decrease the resident time of the current collector in the bath such as to decrease the thickness of a lithium layer on the current collector. By one example form, the lithium layers are formed on both a front and back of the current collector, and may be formed on the sides as well if not masked so that the current collector has a core of copper surrounded by the lithium. Otherwise, the lateral edges of the current collector may have been masked to expose the copper and provide an area on the current collector for taps.

Thereafter, the current collector rises out of the bath and toward an exit roller and take-up roller. The distance from the bath to the rollers in the inert atmosphere at room temperature (or at least below the melting point of lithium) is sufficient to cool and solidify the lithium layers and will not be damaged when the lithium layers are rolled up onto the take-up roller. While not mentioned, it will be understood that intermediate layers, such as a metal oxide layer, also may be part of the resulting layered structure.

Process 400 may include “provide the current collector with the lithium layer to form a lithium metal anode for a battery cell” 408, where the lithium coated current collector may be provided as a roll or may continue being guided to other devices for further treatment.

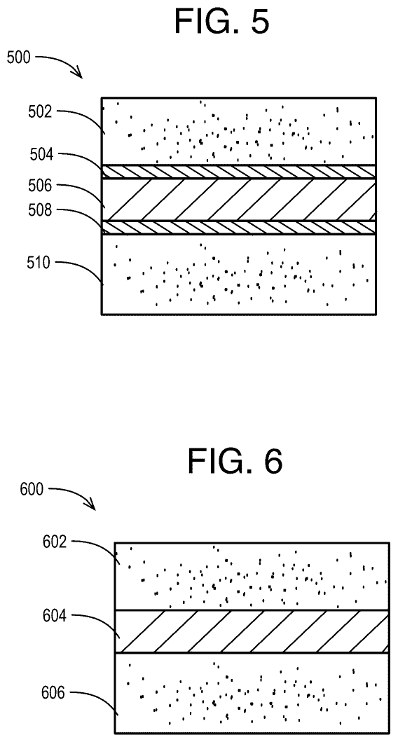

Referring to FIG. 5, an example lithium anode 500 for a battery cell and resulting from the use of the molten lithium bath as described herein has a current collector layer 506 between intermediate metal oxide layers 504 and 508, which each have a lithium layer 502 or 510 mounted on the metal oxide layer 504 and 508, respectively. By one form, the copper (or other core material) of the current collector layer 506 has a thickness of about or exactly 5-20 microns. Also, the metal oxide layers 504 and 508 have a thickness of about or exactly 50-500 nanometers, 100-200 nanometers, or about 100 nanometers. In one implementation, the desired lithium layers 502 and 510 have a thickness on each side of the current collector layer 506 that is about 10-200 microns, about 10-50 microns, or about 10-20 microns.

Referring to FIG. 6, an example lithium anode 600 for a battery cell and resulting from the use of the molten lithium bath as described herein has a current collector 604 between lithium layers 602 and 606 mounted on the current collector 604. The thicknesses of the layers is as mentioned for anode 500.

While at least one example implementation has been presented in the foregoing detailed description, it should be appreciated that a vast number of variations exist. It should also be appreciated that the example implementations are not intended to limit the scope, applicability, or configuration of the disclosure in any way. Rather, the foregoing detailed description will provide those skilled in the art with a convenient road map for implementing the example implementations. It should be understood that various changes can be made in the function and arrangement of elements without departing from the scope of the disclosure as set forth in the appended claims and the legal equivalents thereof.

What is claimed is:

1. A method, comprising:
providing a current collector comprising metal;
forming a lithium layer on at least one side of the current collector comprising dipping the current collector into a bath of molten lithium;
controlling the thickness of the lithium layer at least partly by at least one of: setting a line speed through the bath or a resident time that the current collector is to be within the bath; and
providing the current collector with the lithium layer to form a lithium metal anode for a battery cell.

2. The method of claim 1, wherein the dipping comprises moving the current collector through the bath of molten lithium to provide a lithium layer on both a front and a back of the current collector.

3. The method of claim 1, comprising moving the current collector under at least one fixture; and forcing, by the at least one fixture, the current collector into the molten lithium.

4. The method of claim 3, comprising heating a lower end of the fixture that is directly or indirectly in contact with the current collector in the molten lithium.

5. The method of claim 3, comprising vertically moving the fixture to adjust tension in the current collector.

6. The method of claim 3, wherein the fixture has a lower end with a roller disposed within the molten lithium, and comprising passing the current collector under the roller.

7. The method of claim 6, comprising replacing or adjusting the roller to change the diameter of the roller to adjust tension in the current collector.

8. The method of claim 3, wherein a coating tub has an interior first surface in direct contact with the molten lithium, and comprising:
extending at least one second surface of the at least one fixture into the coating tub and placing the at least one second surface in direct contact with the molten lithium; and
forming the first and second surfaces of a material inert to lithium.

9. The method of claim 8, comprising forming the first and second surfaces of stainless steel or SS-316.

10. A system of making lithium anodes for a vehicle battery, comprising:
a conveyor mechanism having rollers spaced along a path to move a current collector through the system; and
a coating tub to receive the current collector and hold a bath of molten lithium to dip the current collector into the molten lithium, wherein the rollers are arranged to descend the current collector into the bath and to raise the current collector out of the bath.

11. The system of claim 10, comprising at least one heater disposed below the coating tub and disposed to heat the molten lithium in the bath.

12. The system of claim 10, wherein the coating tub has at least one sidewall, and wherein the system comprises at least one heater on the at least one sidewall to heat the bath of molten lithium.

13. The system of claim 12, comprising a plurality of the heaters disposed vertically on the at least one sidewall to each radiate at different temperatures to establish a gradient of temperatures vertically along a depth of the molten lithium within the coating tub.

14. The system of claim 12, wherein the at least one sidewall has at least one indent receiving at least part of the at least one heater.

15. The system of claim 10, wherein the conveyor mechanism comprises a descending portion and a rising portion respectively extending into and out of the bath of molten lithium, and wherein the system comprises at least one heater disposed to be directed toward the current collector on the descending portion.

16. The system of claim 10, comprising: a supply container to hold heated molten lithium; and an injection channel fluidly coupling the supply container to an interior of the coating tub to feed lithium from the supply container into the coating tub.

17. The system of claim 16, wherein the molten lithium in the supply container is maintained at a temperature of about one-half the melting point of lithium or about 100° C. or 100.0° C. or 90.25° C.

18. The system of claim 10, comprising multiple fixtures extending within the coating tub and along a path of the current collector, wherein the multiple fixtures are spaced from each other at a distance within the coating tub, and wherein the multiple fixtures hold the current collector in the molten lithium over the distance.

19. The system of claim 10, wherein one of the rollers is an automatically rotatable take-up roller that winds the current collector with a lithium layer around the take-up roller, and wherein the take-up roller has at least one sensor to sense tension in the current collector.

20. A method, comprising:
moving a metal current collector having front and back metal oxygen layers down into a coating tub holding a bath of molten lithium;
moving the current collector under at least one fixture extending into the coating tub and the molten lithium;
coating both the front and back metal oxide layers on the current collector with a lithium layer of molten lithium;
moving the current collector having the lithium layers upward and out of the coating tub; and
rolling the current collector with the lithium layers onto a take-up roller.
